(19) United States
(12) Patent Application Publication
(10) Pub. No.: US 2015/0047978 A1
(43) Pub. Date: Feb. 19, 2015

(54) BIOSENSOR HAVING NANOSTRUCTURED ELECTRODES

(71) Applicants: Vijaywanth Mathur, Mumbai (IN); Vaishali Nevreker, Mumbai (IN); Rahul Mathew, Mumbai (IN)

(72) Inventors: Vijaywanth Mathur, Mumbai (IN); Vaishali Nevreker, Mumbai (IN); Rahul Mathew, Mumbai (IN)

(73) Assignee: PIRAMAL ENTERPRISES LIMITED, Mumbai, MH (IN)

(21) Appl. No.: 14/384,538

(22) PCT Filed: Mar. 13, 2012
(86) PCT No.: PCT/IB2012/051170

§ 371 Date: Sep. 11, 2014

(51) Int. Cl. G01N 27/327

(52) U.S. Cl. CPC G01N 27/3271
USPC 204/403.14; 204/435; 204/412; 204/409; 204/403.01

(57) ABSTRACT

The present invention provides a substrate for a microfluidic device comprising a polymeric base plate, at least one sensor formed over the polymeric base plate for detecting at least one target analyte from a sample, the sensor comprising at least one reference electrode and at least one working electrode, wherein a plurality of nanostructures deposited over the working electrode for increasing the surface area of the working electrode, and at least one recognition element bound to or deposited over the nanostructures. The microfluidic device of the present invention is a point-of-care, self calibrated, self contained hand-held device for rapid screening and diagnosis of various disease markers.

### FIELD OF THE INVENTION

The present invention relates to an electrochemical immunoassay based microfluidic device. More particularly, the present invention relates to a substrate for the microfluidic device for detecting target analytes in a biological or chemical assay.

### BACKGROUND AND PRIOR ART

Microfluidics devices, first developed in the early 1990s, were initially fabricated in silicon and glass using photolithography and etching techniques adapted from the microelectronics industry, which are precise but expensive and inflexible. The trend recently has moved toward the application of soft lithography-fabrication methods based on printing and molding organic materials. Microfluidics refers to a set of technologies that control the flow of minute amounts of liquids or gases, typically measured in nano- and picoliters- in a miniaturized system. “Unlike microelectronics, in which the current emphasis is on reducing the size of transistors, microfluidics is focusing on making more complex systems of channels with more sophisticated fluid handling capabilities”, says George Whitesides, Mallinckrodt Professor of Chemistry and Chemical Biology at Harvard University.

A microfluidic device can be characterized as having one or more channels with at least one dimension less than 1 mm. The common fluids used in microfluidic devices include whole blood samples, bacterial cell suspensions, protein or antibody solutions and various buffers. The microfluidic devices can be used to obtain a variety of interesting measurements including molecular diffusion coefficients, fluid viscosity, pH, chemical binding coefficients and enzyme reaction kinetics. Other applications for microfluidic devices include capillary electrophoresis, isoelectric focusing, immunoassays, flow cytometry, sample injection of proteins for analysis via mass spectrometry, PCR amplification, DNA analysis, cell manipulation, cell separation, cell patterning and chemical gradient formation. Many of these applications have utility for clinical diagnostics.

In recent years, miniaturization of chemical and biochemical tools has become an expanding field. The use of microfluidic devices to conduct biomedical research and create clinically useful technologies has numerous significant advantages. The main factors encouraging the development of microfluidic devices are the desire for decreased analyte consumption, rapid analysis and improved automation capacity. The need to limit analyte consumption is highlighted by the increasing number of assays that are performed, the use of reactants for analysis requiring to be kept as small as possible in order to reduce costs but also to limit waste production.

Also, conventional assays require samples to be taken and then transferred to a laboratory. The newer devices provide hand held devices which can be used for conducting assays without the need of laboratory instruments.

European Patent Application Publication No. 1391241 discloses a microfluidic device for the detection of target analytes. The microfluidic device employs a solid support, which has a sample inlet port, a storage chamber and a microfluidic channel, connecting the solid support with the sample inlet port and the storage chambers. The printed circuit boards are used as solid supports on which detection electrodes are provided. The detection electrodes are provided by self assembled monolayers, which are specific to a particular substrate, for instance thiols.

PCT Application Publication No. WO2010020574 discloses a microfluidic system for assaying a sample, especially a biological sample. The microfluidic system is configured to allow two samples, such as a test sample and a control, to be processed under the same reaction conditions without cross contamination. The invention also relates to a cartridge system comprising the microfluidic system, and to assays performed using the microfluidic system or cartridge system. The microfluidic system comprises two reaction reservoirs, a reagent delivery channel to deliver reagents to the reaction reservoirs, a waste channel, and a means for retaining one or more reagents in each reaction zone, such as magnetic or magnetizable. The reservoirs are connected to waste chambers. The reservoirs have interconnected chambers which store processing components and sample preparation components. Thus, the apparatus is complex with too many interconnections.

U.S. Pat. No. 7,419,821 discloses a single use disposable cartridge for the determination of an analyte in biological samples using electrochemical immunosensors or other ligand/ligand receptor based biosensors. The cartridge comprises a cover, a base, and a thin film adhesive gasket, which is disposed between the base and the cover. The analyte measurements are performed in a thin-film of liquid coating an analyte sensor and such thin-film determination are performed amperometrically. The cartridge comprising an immunosensor is microfabricated from a base sensor of an unreactive metal such as, gold, platinum or iridium.

PCT Application Publication No. WO2004/061418 describes a cartridge for performing a plurality of biochemical assays. The cartridge comprises a flow cell having an inlet, an outlet and a detection chamber. The inlet, outlet and detection chamber define the flow path through the flow cell. The detection chamber comprises plurality of electrodes involving a dedicated working electrode, a dedicated counter electrode and two or more dual-role electrodes, wherein each of the dual-role electrodes is used as a working electrode for measuring an assay dependent signal, and subsequently as a counter electrode for measuring a different assay dependent signal at a different one of said plurality electrode. The fluidic network is formed within the cartridge employing fabrication method appropriate to the cartridge body material, such as stereolithography, chemical/laser etching, integral molding, machining, lamination, etc.

The microfluidic devices available in the market are manufactured by using micromachining and milling techniques, hence, the microfluidic devices are expensive. Thus, there is a need to develop an inexpensive, hand-held miniature assay device, which can analyze one or more target analytes with high sensitivity and specificity and which provides qualitative as well as quantitative measurements at low concentrations of analytes.

### SUMMARY OF THE INVENTION

The present invention provides a point-of-care, self calibrated, self contained hand-held device for rapid screening and diagnosis of various disease markers.

The present invention provides a substrate for a microfluidic device comprising a polymeric base plate; at least one sensor formed over the polymeric base plate for detecting at least one target analyte contained in a sample, wherein the sensor comprising at least one working electrode and at least one reference electrode; a plurality of nanostructures deposited over the working electrode and a recognition element bound to or deposited over the nanostructures.

The present invention also provides a microfluidic device comprising the substrate, wherein the substrate acts as a bottom layer for the microfluidic device and an electrochemical sensor.

The present invention also provides a microfluidic device, wherein the microfluidic device of the invention further comprises a reagent component comprised of at least one entry point for a sample containing at least one analyte, at least one reservoir for storing reagent and a waste chamber for disposing the used reagent; and a gasket for adhering the substrate to the reagent component.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of accompanying drawings in which:

FIG. 1 illustrates a schematic view of a substrate for a microfluidic device in accordance with an embodiment of the present invention.

FIG. 2 illustrates a schematic sectional view of a gasket adhered to a substrate for a microfluidic device in accordance with an embodiment of the present invention.

FIG. 3 illustrates an isometric view of a microfluidic device according to an embodiment of the present invention.

FIG. 4 illustrates a standard graph of the current generated (at 0.2 sec) in an amperometric measurement of the product produced versus the HbA1c percentage.

Together with the following description, the figures demonstrate and explain the principles of the microfluidic devices and methods for using the microfluidic devices in biological or chemical assay. The thickness and configuration of components of microfluidic device, illustrated in the figures, may be expanded for clarity. The same reference numerals in different figures represent similar, through necessarily identical components.

### DETAILED DESCRIPTION OF THE INVENTION

### Definitions

Before describing the present invention in detail, it has to be understood that this invention is not limited to particular embodiments described in this application. It is also to be understood that the terminology used herein is for the purpose of describing particular embodiments only and is not intended to be limiting.

As used in the specification and claims, singular terms including, but not limited to, “a”, “an” and “the” include plural references unless the context clearly indicates otherwise. Plural terms include singular references unless the context clearly indicates otherwise. Unless defined otherwise, all technical and scientific terms used herein have the same meaning as commonly understood by one of the ordinary skill in the art to which the invention belongs.

According to this invention, the term “nanostructures” refers to structures that possess the nanometer size and has partial or complete nanometer effect (e.g. surface effect, size effect).

According to this invention, the term “nanoparticles (NPs)” refers to solid particles, which, in three-dimensional space, have at least one-dimensional size less than 500 nm, preferably less than 100 nm, optimally less than 50 nm.

According to this invention, the term “nanotubes (NTs)” specifically refers to hollow-core nanostructures with a diameter less than 10 nm.

According to this invention, the term “target analyte” refer to a specific material, the presence, absence, or amount of which is to be detected, and that is capable of interacting with a recognition element. The targets that may be detected include, without limitation, molecules, compounds, complexes, nucleic acids, proteins, such as enzymes and receptors, viruses, bacteria, cells and tissues and components or fragments thereof. Exemplary, samples containing target analyte includes, without limitation, whole blood sample, serum, urine, stool, mucus, sputum and tissues etc.

The invention described herein is explained using specific exemplary details for better understanding. However, the invention disclosed can be worked on by a person skilled in the art without the use or by obvious modification in the specific details as discussed herein below.

While this invention has been described as having a specific design, the present invention can be further modified within the spirit and scope of this disclosure. This application is therefore intended to cover any variations, uses, or adaptations of the invention using its general principles. Further, this application is intended to cover such departures from the present disclosure as appear within known or customary practice in the art to which this invention pertains.

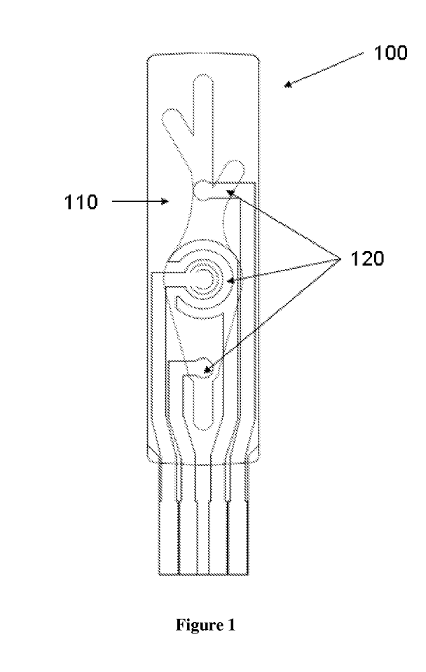

The present invention relates to a substrate for a microfluidic device, comprising a polymeric base plate; at least one sensor formed over the polymeric base plate for detecting at least one target analyte contained in a sample, wherein the sensor comprises at least one working electrode and at least one reference electrode; a plurality of nanostructures deposited over the working electrode; and a recognition element bound to or deposited over the nanostructures. The nanostructures deposited over the working electrode for increasing the surface area of the working electrode. The FIG. 1 illustrates a substrate (denoted by the numeric 100) for a microfluidic device.

In an embodiment of the present invention, the substrate (100), as represented in FIG. 1 comprises a polymeric base plate (denoted by the numeric 110) and a sensor (denoted by the numeric 120), which is formed over polymeric base plate for detecting target analyte contained in a sample.

In accordance with an embodiment of the present invention, the polymer used in the polymeric base plate (110) is selected from polyester, polystyrenes, polyacrylamides, polyetherurethanes, polysulfones, polycarbonates or fluorinated or chlorinated polymers such as polyvinyl chloride, polyethylenes and polypropylenes. Other polymers include polyolefins such as polybutadiene, polydichlorobutadiene, polyisoprene, polychloroprene, polyvinylidene halides, polyvinylidene carbonate, and polyfluorinated ethylenes. The copolymers, including styrene/butadiene, alpha-methyl styrene/dimethyl siloxane, or other polysiloxanes such as, polydimethyl siloxane, polyphenylmethyl siloxane and polytrifluoropropylmethyl siloxane may also be used. Other alternatives include polyacrylonitriles or acrylonitrile containing polymers such as poly alpha-acrylanitrile copolymers, alkyd or terpenoid resins, and polyalkylene polysulfonates. However, the material used for forming the polymeric base plate is not limited to those materials listed above and can be any material which has chemical and biological stability and processability.

In accordance with an embodiment of the present invention, the sensor includes at least one working electrode, at least one reference electrode and optionally a counter electrode. These electrodes are formed over metal coated polymeric base plate by using a laser technique, such as laser ablation. According to an embodiment of the present invention, the metals are coated over the polymeric base plate (110) by sputtering technique. The sensor may also be formed over polymeric base plate using a screen printing technique. However, it may be apparent to a person skilled in the art to replace sputtering with any other suitable technique known in the art.

In accordance with an embodiment of the present invention, the noble metal coated over the polymeric base plate is selected from gold, platinum or palladium. According to an embodiment of the present invention, the polymeric base plate (110) is sputtered with gold and the sensors are ablated with laser technique over the base plate (110). Alternatively, the sensors are printed on polymeric base plate using screen printing.

In accordance with an embodiment of the present invention, the sensor (120) including the working electrode is deposited with a plurality of nanostructures, which increases the surface area of the working electrode. The increase in surface area of the working electrode increases the sensitivity and accuracy of the assay to be performed even with very low quantities of target analyte. The non-limiting exemplary nanostructures according to the present invention are selected from carbon nanotubes (CNTs) or gold nanoparticles.

In accordance with an embodiment of the present invention, the nanostructures are gold nanoparticles deposited over the working electrode using the electro deposition technique. In an embodiment, the nanostructures are carboxylated carbon nanotubes and the percentage of carboxylation of carbon nanotubes is 3% to 5%.

In accordance with an embodiment of the present invention, the working electrode (120) of the sensor is ablated in the form of concentric arcs, circle, spiral, helix or any polygonal shape to increase the deposition of nanostructures. The “polygonal” shape is a multi-sided, closed planar shape. The Polygons may include trigons (or triangles), tetragons (or quadrilaterals), pentagons, hexagons, heptagons, octagons, and the like. Tetragons may include squares and rectangles, which have four sides connected at four right angles. Tetragons also may include rhombi (e.g. diamond-shaped polygons or parallelograms), which do not include four right angles. According to an embodiment of the present invention, the working electrode is ablated in the form of concentric arcs. The concentric arcs of the working electrode are in a hill-valley type arrangement providing better deposition of the nanostructure. The working electrode has a diameter in the range of 2 mm to 8 mm.

The nanotubes deposited working electrode are further bound to or deposited with a recognition element. The recognition element is bound to nanotubes using coupling chemistry, such as the 1-ethyl-3-(3-dimethylaminopropyl)carbodiimide/N-hydroxysuccinimide (EDC/NHS) coupling chemistry. The non-limiting examples of the recognition element are antigens, antibodies, enzymes, aptazymes and aptamers. In accordance with an embodiment of the present invention, the target analyte containing sample is selected from the group comprising of whole blood, serum and urine.

In accordance with an embodiment of the present invention, the substrate optionally comprises at least one fluid detection sensor formed over the polymeric base plate for detecting the presence of the analyte and at least one reagent involving reading reagent or reaction reagent.

The reading reagent is the electrochemical substrate solution such as napthyl phosphate that is used in the Enzyme-Linked Immunosorbent Assay (ELISA). The reaction reagent is a reagent comprising of conjugate or secondary antibody that is enzyme labeled that is used in the ELISA.

Chronoamperometry is an electrochemical technique of measurement whereby appropriate voltage is applied across the working and reference electrodes and the resulting current for the electrochemical reaction is measured between the working and reference electrode.

The present invention also relates to a microfluidic device comprising a substrate according to the present invention, a reagent component and a gasket for adhering the substrate to the reagent component.

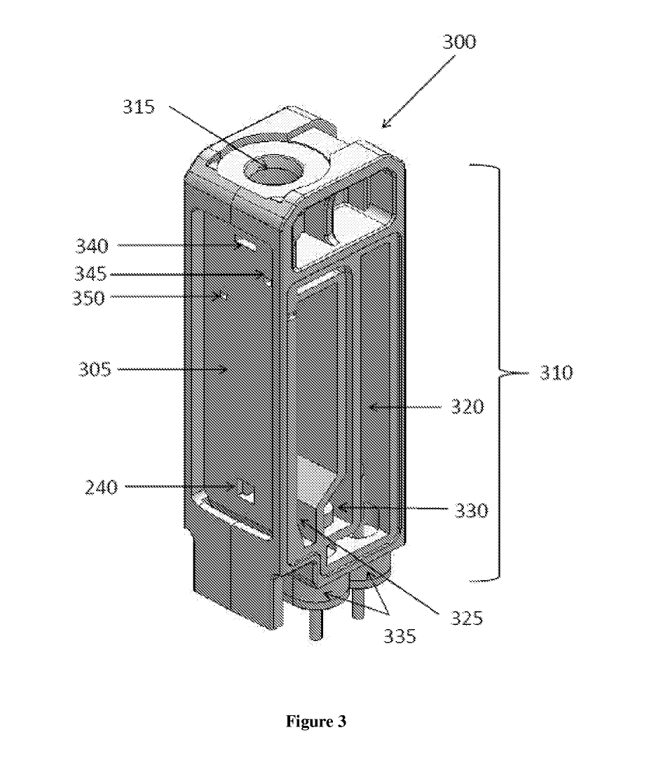

In accordance with another embodiment of the present invention, the microfluidic device (denoted by the numeric 300) represented in FIG. 3. The substrate (100) of the microfluidic device serves dual purpose, wherein the substrate acts as a bottom layer for the microfluidic device and also as an electrochemical sensor.

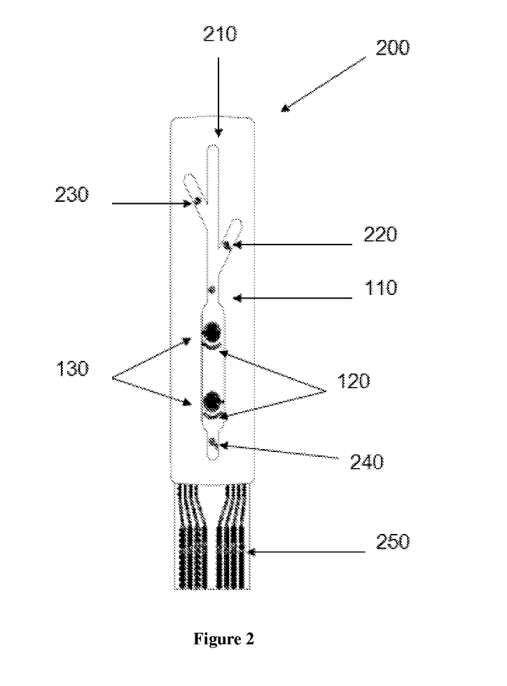

In accordance with another embodiment of the present invention, the FIG. 2 represents a gasket which adheres the substrate (100) to the reagent component. According to the present invention, the gasket is a double sided pressure sensitive adhesive. The gasket is laser cut to define the fluidic path of the sample and the reagents from the component to the sensor (120) of the substrate (100) through microfluidic channels on the substrate. The gasket acts as a spacer between the reagent component and the substrate along with the microfluidic channels for the flow of the sample. The thickness of the gasket is between 100 μm to 400 μm. In an embodiment of the present invention the thickness of the gasket is ≧200 μm. The flow of the sample (denoted by the numeric 210), the reagents through the microfluidic channels on the substrate and the gasket is through capillary action.

In accordance with another embodiment of the present invention, the used reagents and the sample is then dispensed to the waste chamber in the microfluidic device through a dump (denoted by the numeric 240).

The connector region of the substrate (denoted by the numeric 250) facilitates the positioning of the substrate in the microfluidic device in the slot of the microfluidic device.

The substrate (100) adhered to a gasket on one side shown in FIG. 2 is positioned in a slot provided for the substrate in the reagent component (denoted by the numeric 310). The reagent component comprises an entry point (denoted by the numeric 315) for a sample containing at least one target analyte, a reservoir for storing a reagent (denoted by the numeric 320), and a waste chamber (denoted by the numeric 325) for disposing the used reagent.

The FIG. 3 representing the microfluidic device contains two reservoirs, first reservoir (320) and second reservoir on the other side of the first reservoir; one reservoir is for storing reaction reagent and other one is for storing a reading reagent. The first and the second reservoirs are formed by a partition which separates the reaction reagent from the reading reagent. However, there can be more than one reaction reagent and reading reagent based on the type of assay to be performed. Additionally, there may be more than one reservoir for storing reaction reagents. The present invention is not restricted to the number of reservoirs or to the location of the reservoirs. The arrangements may vary according to the assay to be performed which will be apparent to a person skilled in the art.

In accordance with another embodiment of the present invention, the microfluidic device further comprises at least one conduit for dispensing the reagents from the reservoir to the substrate. The microfluidic device as shown in FIG. 3 comprises two conduits, one each for dispensing the reaction reagent and the reading reagent to the substrate. First conduit (denoted by the numeric 330) is used to dispense the reaction reagent from the first reservoir (320) to the substrate and second conduit is positioned behind the first conduit and is used to dispense the reading reagent from the second reservoir to the substrate.

In accordance with another embodiment of the present invention, the microfluidic device further comprises compressed air entry septa (denoted by the numeric 335) which are pierced with a needle. The compressed air displaces the reagents stored in the reservoirs and allows the reagents to flow through the conduits into the substrate.

In accordance with another embodiment of the present invention, the microfluidic device further comprises holes in the reagent chamber, where the substrate is positioned (denoted by the numeric 305) for entry of the sample (denoted by the numeric 340), the reaction reagent (denoted by the numeric 345) and the reading reagent (denoted by the numeric 350).

In accordance with another embodiment of the present invention, the sample containing the target analyte, the reaction reagent and the reading reagent flow through the holes in the reagent chamber to the sensor(s) present on the substrate through the microfluidic channels provided by the gasket. The target analyte present in the sample binds to the recognition element bound on the nanostructures and a signal is generated, which may be used to detect the analyte quantitatively and/or qualitatively. The method for detection of the target analytes will vary depending on the type of assay and can be easily apparent to a person skilled in the art. In accordance with embodiments of the present invention, it is possible to detect multiple target analytes from a sample. The recognition elements will be selected based on the target analytes of interest.

In accordance with the present invention the “recognition element” refers to any chemical, molecule or chemical system that is capable of interacting with a target molecule. The recognition elements can be, for example and without limitation, antibodies, antibody fragments, peptides, proteins, glycoproteins, enzymes, nucleic acids such as oligonucleotides, aptamers, DNA, cDNA and RNA, organic and inorganic molecules, sugars, polypeptides and other chemicals.

In accordance with embodiments of the present invention, the microfluidic device of the present invention is self-calibrated. Each sensor on the substrate is pre-calibrated and the calibration value(s) is mentioned over the device.

According to a further embodiment, the invention relates to use of the microfluidic device to perform at least one of chemical and biological analysis.

According to an embodiment, the microfluidic device is used to perform immunoassays.

An immunoassay combines the principles of chemistry and immunology for a specific and sensitive detection of the analytes of interest. The basic principle of this assay is the specificity of the antibody-antigen reaction. The analytes in biological liquids (samples) such as serum or urine are frequently assayed using immunoassay methods. In essence, the method depends upon the fact that the analyte in question is known to undergo a unique immune reaction with a second substance, which is used to determine the presence and amount of the analyte. This type of reaction involves the binding of one type of molecule, the antigen, with a second type, the antibody. Immunoassay is widely used to detect analytes using antibodies. Most immunoassays are heterogeneous: the antigen-antibody complex is bound to a solid substrate, and free antibodies are removed by washing. In homogeneous immunoassays, the free and bound antibodies do not need to be separated via a solid substrate. These types of procedures minimize washing steps and fluid handling, but they require that the free and antigen-bound antibodies exhibit different electrophoretic mobilities. Miniaturization of homogeneous immunoassays offers advantages, but more work has been done on the miniaturization of heterogeneous immunoassays than of homogeneous immunoassays.

The radioimmunoas say, using radioactively labeled antigens or antibodies was the only preference available for conducting immunoassay before the development of Enzyme-Linked Immunosorbent Assays (ELISAs). Elisa is a popular format of a “wet-lab” type analytic biochemistry assay that uses one sub-type of heterogeneous, solid-phase enzyme immunoassay (EIA) to detect the presence of a substance in a liquid sample or wet sample. Elisa's are typically performed in 96-well or 384-well polystyrene plates, which will passively bind antibodies and proteins. It is his binding and immobilization of reagents that makes elisa so easy to design and perform. The reactants of the elisa immobilized to the microplate surface makes it easy to separate bound from non-bound material makes the elisa a powerful tool for measuring specific analytes within a crude preparation.

Thus, the method for preparation of sensor, immobilized with the capture antibody for the analysis is briefly described herein below:

### Step I: Cleaning of Sensors

The laser ablated sensors were cleaned using a gold cleaning solution (GCS). For cleaning, the sensors were dipped in GCS:DI water (1:1) solution for 5 minutes and were then rinsed thoroughly with demineralized water (DI water).

Step II: Coating of Sensor by Conduction Agent i.e. Drop Casting of COOH-CNTs on the Gold Sputtered Sensor Surface

Multi-walled carboxylated carbon nanotubes (COOH-CNTs) solution was prepared by adding COOH-CNTs in 0.1M diethanolamine buffer to get a final concentration of 20 mg/ml. The 6 μl of COOH-CNTs solution was drop casted on the sensor gold surface (which is used as reference electrode). The COOH-CNTs was dried at 60° C. for 10 minutes.

### Step III: Immobilization of Capture Mc Hb

Capture antibody (Monoclonal antiHb) was immobilized on the COOH-CNTs through EDC-NHS coupling. Initially the COOH-CNTs surface was activated by treating it with EDC-NHS for 30 minutes followed by addition of 30 μl of capture antibody (50 mcg/ml). The antibody immobilization was carried out for 3 hours at room temperature. Blocking was done using Stabilcoat or 1% BSA for 30 minutes at room temperature. Excess Stabilcoat was removed, washed with phosphate buffer and were stored at 2-8° C. under N₂ atmosphere, till further use.

### Examples

### Preparation of the Substrate for Microfluidic Device

A polymeric base plate of polyester was sputtered with gold. The sensors comprising working electrodes, reference electrodes and a counter electrode were formed over the polymeric base plate using laser ablation. The working electrodes were formed in the shape of concentric arcs of 2 mm to 8 mm diameter. A solution (3-50) containing CNTs was poured over the sensors and the solution was allowed to dry. The CNTs bound to the working electrodes, wherein the carboxyl groups of the CNTs coupled to the recognition element, for instance HbA1c antibodies using coupling chemistry. The substrate was fitted in the microfluidic device via the connector.

### HbA1c Testing Using the Microfluidic Device

A diluted blood sample (100 μl) (1 uL of blood sample diluted to 100 μl by Mfr. diluent) was poured to the microfluidic device containing the substrate. The blood sample containing the HbA1c antigens was allowed to flow in the microfluidic channels by capillary action and react with HbA1c antibodies already present on the substrate, which are coupled to the carboxylated nanotubes. The blood sample was allowed to incubate for 5 minutes after which the reaction reagent was pumped by means of a micro solenoid pump. Then the reading reagent was pumped to take the electrochemical reading. The fluid detection sensors present on the substrate let the device know that blood sample or the reaction reagent or reading reagent were present in front of the electrochemical sensors.

### Measurement of HbA1c

### Using HbA1c Controls

2 μl of the HbA1c Controls such as, L1 (4.78% concentration of HbA1c), L2 (7.37% concentration of HbA1c) is mixed with 198 μl of the lysing agent. 1 mM Cetyl trimethylammonium bromide (CTAB) prepared in phosphate buffer is used in this case.

Using Whole Blood samples

2 μl of the whole blood sample is mixed with 198 μl of the lysing agent. 1 mM CTAB prepared in phosphate buffer is used in this case.

50 μl of the diluted sample was added on the sensor and incubated for 5 minutes at room temperature.

The sensors were washed twice with PBT (Phosphate Buffer pH 7.0 with 0.002% Tween-20).

30 μl of conjugated secondary antibody (10 mcg/ml Mc HbA1c) was added on the sensor and was incubated for 5 minutes at room temperature.

The sensors were then washed twice with PBT (Phosphate Buffer pH 7.0 with 0.002% Tween-20).

50 μl of the substrate, 10 mM para-napthyl phosphate was added on the sensors and was incubated for 2 minutes at room temperature.

Amperometric measurement of the product produced (napthol) was recorded.

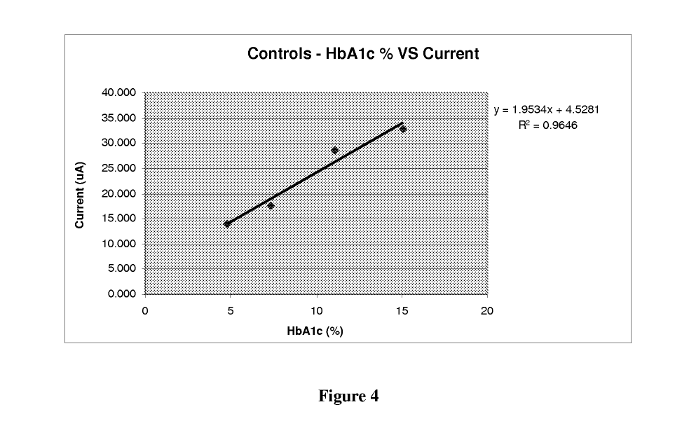

A standard graph of the current generated (at 0.2 sec) versus the HbA1c % was plotted in FIG. 4.

| Controls-HbA1c % | Avg. Current at 0.2 sec (μA) |
|---|---|
| 4.78 | 13.930 |
| 7.37 | 17.620 |
| 11.1 | 28.565 |
| 15.1 | 32.910 |

The microfluidic device of the present invention is a self-calibrated, self contained hand-held device for rapid screening and diagnosis of various disease markers. It is also a high performance device in terms of sensitivity and specificity, which adds an advantage of quantitative measurements of low concentrations of disease markers in whole blood/serum. Moreover, the device of the present invention is inexpensive as it does not require any micro-processing for production of the device. The device of the present invention is a “Lab on a cartridge” as it performs all the functions of a laboratory instruments.

In the above description, certain specific details of disclosed embodiments such as specific materials, designs etc. are set forth for purposes of explanation rather than limitation, so as to provide a clear and thorough understanding of the present invention. However, it should be understood readily by those skilled in this art, that the present invention may be practiced in other embodiments without departing from the spirit and scope of this disclosure which is illustrated by the appended claims.

1. A substrate for a microfluidic device, comprising:
a polymeric base plate;
at least one sensor formed over the polymeric base plate for detecting at least one target analyte contained in a sample,
wherein the sensor comprising at least one working electrode and at least one reference electrode; a plurality of nanostructures deposited over the working electrode for increasing the surface area of the working electrode, and
a recognition element bound to or deposited over the nanostructures.

2. The substrate as claimed in claim 1, wherein the polymeric base plate is metal coated.

3. The substrate as claimed in claim 2, wherein the sensor is formed over the metal coated polymeric base plate using laser ablation.

4. The substrate as claimed in claim 2, wherein the polymeric base plate is coated with the metal by sputtering.

5. The substrate as claimed claim 4, wherein the polymeric base plate is coated with a metal selected from the group consisting of noble metals such as gold, palladium or platinum.

6. The substrate as claimed in claim 1, wherein the sensor is formed over the polymeric base plate using screen printing.

7. The substrate as claimed in claim 1, wherein the polymeric base plate is made using a polymer; wherein the polymer is selected from polyester, polystyrenes, polyacrylamides, polyetherurethanes, polysulfones, polycarbonates or fluorinated or chlorinated polymers such as polyvinyl chloride, polyethylenes or polypropylenes.

8. The substrate as claimed in claim 1, wherein the working electrode is in the form of concentric arcs, circle, spiral, helix or polygonal shape.

9. The substrate as claimed in claim 8, wherein the working electrode is in the form of concentric arcs.

10. The substrate as claimed in claim 9, wherein the concentric arcs of the working electrode are in a hill-valley type arrangement.

11. The substrate as claimed in claim 1, wherein the working electrode has a diameter in the range of 2 mm to 8 mm.

12. The substrate as claimed in claim 1, wherein the nanostructures are selected from carbon nanotubes or gold nanoparticles.

13. The substrate as claimed in claim 12, wherein the gold nanoparticles are deposited over the working electrode by electro deposition.

14. The substrate as claimed in claim 12, wherein the carbon nanotubes are carboxylated.

15. The substrate as claimed in claim 14, wherein the percentage of carboxylation of the carbon nanotubes is 3% to 5%.

16. The substrate as claimed in claim 1, wherein the recognition element is selected from the group consisting of antigens, antibodies, enzymes, aptazymes, or aptamers.

17. The substrate as claimed in claim 1, wherein the sensor optionally comprises counter electrode.

18. The substrate as claimed in claim 1, wherein the substrate optionally comprises at least one fluid detection sensor formed over the polymeric base plate for detecting the presence of the sample and at least one reading reagent and reaction reagent.

19. A microfluidic device comprising:
a substrate as claimed in claim 1;
a reagent component comprising at least one entry point for a sample containing at least one target analyte, at least one reservoir for storing a reagent and a waste chamber for disposing used reagent; and
a gasket for adhering the substrate to the reagent component, wherein the gasket defines a fluidic path of the sample and the reagent from the reagent component to the sensor of the substrate.

20. The microfluidic device as claimed in claim 19 further comprising at least one conduit for dispensing the reagent from the reservoir to the substrate.

21. The microfluidic device as claimed in claim 19, wherein said substrate acts as electrochemical sensor and a bottom layer for the microfluidic device.

22. The microfluidic device as claimed in claim 19, wherein the gasket is a double sided pressure sensitive adhesive.

23. The microfluidic device as claimed in claim 22, wherein the gasket is laser cut to define the fluidic path.

24. The microfluidic device as claimed claim 19, wherein the thickness of the gasket is between 100 μm to 400 μm for free flowing of the sample through the fluidic path.

25. The microfluidic device as claimed in claim 24, wherein the thickness of the gasket is ≧200 μm.

26. The microfluidic device as claimed claim 19, wherein the sample containing target analyte is selected from whole blood, serum or urine.

27. The microfluidic device as claimed in claim 19, wherein the device is pre-calibrated and the calibration value is mentioned over the device.

28. The microfluidic device as claimed in claim 19 used to carry out at least one of chemical and biological analysis.

29. The microfluidic device as claimed in claim 28, wherein the device is used to carry out immunoassays.
